(19) United States
(12) Patent Application Publication
(10) Pub. No.: US 2020/0147721 A1
(43) Pub. Date: May 14, 2020

(54) LASER LIGHT SOURCE MODULE

(71) Applicant: TOPAPEX OPTRONICS TECHNOLOGY CO.,LTD., Taipei (TW)

(72) Inventors: Hung-Tu LU, Taipei (TW); Alexander NAUMOV, Taipei (TW); Chun-Ta LIN, Taipei (TW)

(21) Appl. No.: 16/560,808

(22) Filed: Sep. 4, 2019

(30) Foreign Application Priority Data
Nov. 10, 2018 (TW) 107139978

(51) Int. Cl. B23K 26/146; B23K 26/06; B23K 26/08; B23K 26/70

(52) U.S. Cl. CPC B23K 26/146; B23K 26/703; B23K 26/0884; B23K 26/0608

(57) ABSTRACT

The present invention discloses a laser light source module for subjecting a plate, it includes a substrate, a first light source, a second light source, a temperature reduction unit, a first modification module, a second modification module and a third modification module. The first light source emits a first light beam in the direction of an emitted area of the substrate; the second light source emits a second light beam in the direction of the emitted area of the substrate; the first modification module modifies an optical characteristic of the second light beam; the second modification module modifies the location of the plate that is subjected to the first light beam, the second light beam and/or the temperature reduction unit; and the third modification module is connected to the temperature reduction unit for modifying the angle.

### FIELD OF THE INVENTION

The present invention relates to the field of substrate processing and more particularly to a laser light source module applicable to plate processing.

### BACKGROUND OF THE INVENTION

Traditionally, plate processing includes subjecting a plate (e.g. glass, sapphire, silicon, gallium arsenide, ceramic or the like) to processing (such as heating, cutting and drilling) with, for example a laser light.

However, a conventional “laser-and-nozzle” processing approach typically involves first cutting the plate and then spraying the plate with water for cooling. As such, the nozzle is disposed after the laser. Therefore, cutting can only be performed in just one direction with the laser light during processing. If an irregular-shaped plate is encountered, for example, if an “R”-shaped plate is to be cut, cutting can only be accomplished by rotating the plate.

In light of the above, the present invention provides a laser light source module to solve the conventional problem.

### SUMMARY OF THE INVENTION

A first objective of the present invention is to provide a laser light source module capable of meeting the requirements of various different plates by adjusting a first light beam, a second light beam, a substrate and a temperature reduction unit using a plurality of modification modules.

A second objective of the present invention is to provide the laser light source module above for providing a temperature reduction unit output medium to dissipate the heat energy generated when the plate is subjected to the light beams.

A third objective of the present invention is to provide the laser light source module above for providing a processing unit to operatively drive a first modification module, a second modification module and a third modification module.

A fourth objective of the present invention is to provide the laser light source module above for providing an input/output (I/O) unit for receiving control signals and outputting them to the processing unit to drive the first modification module, the second modification module and the third modification module. Alternatively, the I/O unit can receive control signals and drive the first modification module, the second modification module and the third modification module.

In order to achieve the above and the other purposes, the present invention provides a laser light source module for subjecting a plate to treatment. The laser light source module may include a substrate, a first light source, a second light source, a temperature reduction unit, a first modification module, a second modification module and a third modification module. The substrate is defined with a setting area and an emitted area on two sides thereof. The plate is disposed in the emitted area. The first light source is disposed in the setting area for generating a first light beam emitted in the direction towards the emitted area. The second light source is disposed in the setting area for generating a second light beam. The temperature reduction unit is disposed in the emitted area. The first modification module is coupled to the second light source for modifying an optical characteristic of the second light beam. The second modification module is disposed in the emitted area and coupled to the substrate for modifying the location of the plate that is subjected to the second light beam, the first light beam and/or the temperature reduction unit. The third modification module is disposed in the emitted area. The third modification module is optionally co-axially disposed with the second modification module. The third modification module is connected to the temperature reduction unit for modifying the angle at which the plate is required to be subjected to the temperature reduction unit.

Compared to the prior art, the laser light source module provided by the present invention is capable of performing processing by further modifying modules based on the characteristics (e.g. the material, the shape, etc.) of the plate. The first modification module may be an optical component, a movable part and/or a rotating part for modifying optical characteristics, such as the direction, angle, size, focus and optical path, of the speckle of the light beam. The second modification module may be a movable part and/or a rotating part. The second modification module may simultaneously or independently modify the locations of the plate that are subjected to the second light beam and the temperature reduction unit. The number of the second modification module may be one or more. The third modification module may be a movable part and/or a rotating part.

### BRIEF DESCRIPTION OF THE DRAWINGS

FIG. 1 is a schematic diagram depicting a top view of a laser light source module in accordance with a first embodiment of the present invention.

FIG. 2 is a schematic diagram depicting a side view of the laser light source module of FIG. 1.

FIG. 3 is a schematic diagram depicting a top view of a laser light source module in accordance with a second embodiment of the present invention.

### DETAILED DESCRIPTION OF THE EMBODIMENTS

In order to fully understand the objectives, features and technical effects of the present invention, the prevent invention is illustrated in details with embodiments below with reference to the attached drawings.

In the present invention, the term “a”, “an” or “one” may be used to describe units, elements or components recited herein. This is merely for convenience, and allows a general meaning to be provided to the scope of the present invention. Therefore, unless explicitly stated otherwise, these descriptions are to be construed as including one and at least one, and the singular form may also encompass the plural form.

In the present invention, the term “including”, “comprising”, “having” or “containing” or other similar terms are intended to encompass non-exclusive inclusion. For example, an element, a structure, an article or a device including a plurality of required items is not limited to those listed herein, but may also include other items not listed herein but are typically inherent in the element, the structure or the article, or the device. In addition, the term “or” refers to an inclusive “or” rather than an exclusive “or”, unless expressly stated to the contrary.

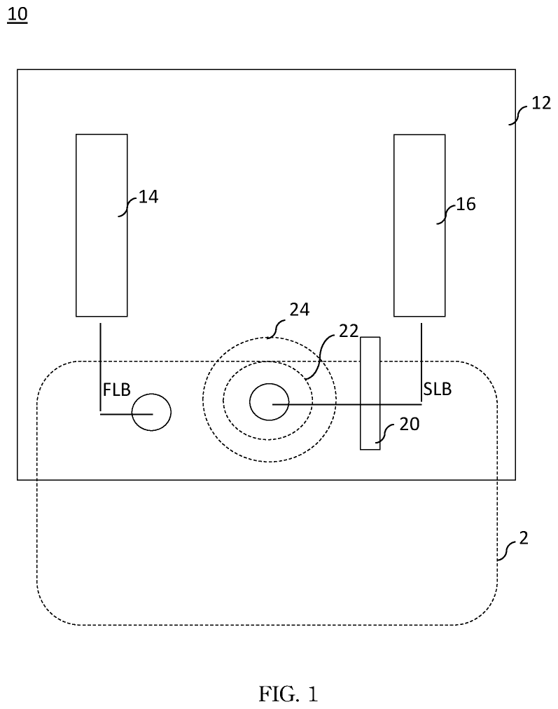

Referring to FIG. 1, which is a schematic diagram depicting a top view of a laser light source module in accordance with a first embodiment of the present invention. In FIG. 1, a plate 2 is subjected to treatments by a laser light source module 10. The plate 2 can be, for example, glass, sapphire, silicon, gallium arsenide, ceramic or the like. Moreover, the aforementioned treatments may include, for example, heating, cutting, drilling etc. of the plate 2.

The laser light source module 10 includes a substrate 12, a first light source 14, a second light source 16, a temperature reduction unit 18, a first modification module 20, a second modification module 22 and a third modification module 24.

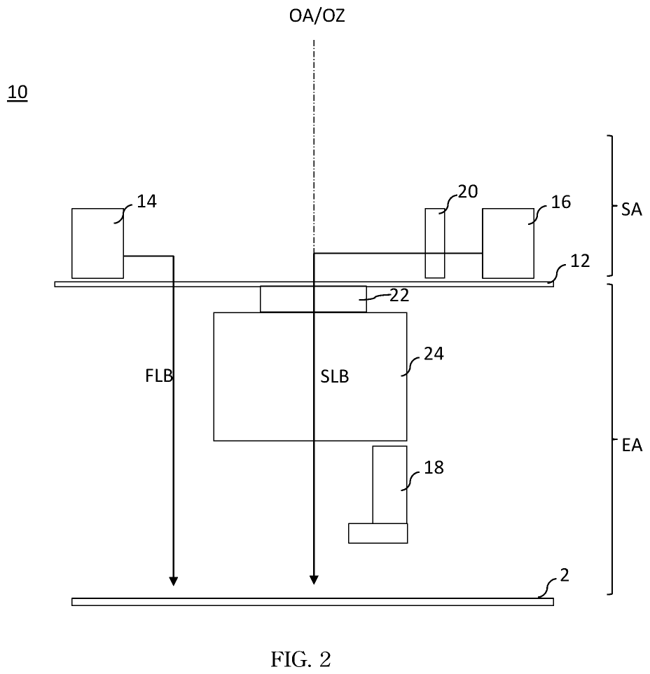

A setting area SA and an emitted area EA are defined on either side of the substrate 12. Descriptions are illustrated in conjunction with FIG. 2, which is a schematic diagram depicting a side view of the laser light source module of FIG. 1. In this embodiment, the setting area SA refers to an area where the first light source 14, the second light source 16 and the first modification module 20 are provided, whereas the emitted area EA refers to an area where the plate 2 is subjected to treatments, and in this embodiment, the plate 2, the temperature reduction unit 18, the second modification module 22, and the third modification module 24 are provided in this area.

In this embodiment, the first light source 14 is disposed on the right side of the setting area SA. The first light source 14 can be an ultraviolet (UV) laser or other types of laser. The first light source 14 generates a first light beam FLB, which is emitted towards the emitted area EA to allow the first light beam FLB to impinge upon the plate 2 in the emitted area EA.

In this embodiment, the second light source 16 is disposed on the left side of the setting area SA. The second light source 16 can be a carbon dioxide laser or other types of laser. The second light source 16 generates a second light beam SLB.

The temperature reduction unit 18 is disposed in the emitted area EA. It dissipates the heat energy produced when the plate 2 is subjected to the first light source 14 and the second light source 16 using liquid, gas or solid. In this embodiment, the temperature reduction unit 18 is a nozzle that provides cooling water, for example.

The first modification module 20 is coupled to the second light source 16 for changing the optical characteristics of the second light beam SLB. For example, the optical characteristics may include the direction, angle, size, focus, optical path, or the like of the speckle of the second light beam SLB, wherein the shape of a speckle pattern may be symmetrical, such as in the shape of a rectangle, a square, a circle, a star, a heart, an ellipse, a teardrop, etc., or asymmetrical. In this embodiment, after the second light beam SLB is adjusted by the first modification module 20, the optical axis OA of the second light beam SLB coincides with the axis OZ of the second modification module 22. In another embodiment, the optical axis OA of the second light beam SLB can be parallel to the axis OZ of the second modification module 22. For example, the first modification module 20 may be a reflecting mirror, by which the second light beam SLB is reflected towards the second modification module 22, and is then emitted to the plate 2 from the axis OZ of the second modification module 22.

The aforementioned first modification module 20 may be an optical component (a lens, a reflecting mirror or a polarizer), a movable part (a gear, a rail, a belt, a drive motor, a servo motor, etc.), a rotating part (a rod, a bearing, a gear, a belt, a drive motor) or a combination of the above. In the present invention, the first modification module 20 is not limited to any functional combinations. It would be deemed as within the scope of the first modification module 20 as long as it is capable of modifying the optical characteristics (e.g. the direction, angle, size, focus, optical path, etc.) of the speckle of the second light beam SLB.

The second modification module 22 is disposed in the emitted area EA. The second modification module 22 is coupled to the substrate 12 for modifying the location(s) of the plate 2 that is subjected to the second light beam SLB and/or the temperature reduction unit 18. The second modification module 22 can be a movable part, a rotating part or a combination of both. In the present invention, the second modification module 22 is not limited to any functional combinations. It would be deemed as within the scope of the second modification module 22 as long as it simultaneously changes the locations of the plate 2 that are subjected to the second light beam SLB, the first light beam FSB and the temperature reduction unit 18, or as long as it separately changes the locations of the plate 2 that are subjected to the second light beam SLB and the temperature reduction unit 18. It can be appreciated from the descriptions that the number of the second modification module 22 may one or more.

In this embodiment, the number of the second modification module 22 is one for illustrative purpose only. In this case, the second modification module 22 will simultaneously change the second light beam SLB and the temperature reduction unit 18 through motions along the z-axis. In terms of the second light beam SLB, the location of its focus/focal length is adjusted through modification in the z-axis by the second modification module 22. In terms of the temperature reduction unit 18, the height of the cooling water above the plate 2 is adjusted through modification in the z-axis by the second modification module 22.

In another embodiment, the number of the second modification module 22 are two for illustrative purpose only. In this case, the second modification module 22 may have two z-axes. For example, the second light beam SLB is associated with first z-axis while the temperature reduction unit 18 is associated with the second z-axis. Therefore, the location of the focus/focal length of the second light beam SLB can be adjusted according to the motions of the second modification module 22 in the first z-axis. However, this will not affect any changes in the temperature reduction unit 18 along the second z-axis. In other words, the height of the cooling water of temperature reduction unit 18 above the plate 2 can be independently adjusted by the motions of the second modification module 22 in the second z-axis.

The third modification module 24 is disposed in the emitted area EA. In this embodiment, the third modification module 24 and the second modification module 22 are optionally disposed co-axially, and the third modification module 24 covers the second modification module 22. The third modification module 24 is connected to the temperature reduction unit 18 for changing the angle at which the plate 2 is required to be subjected to the temperature reduction unit 18. In other words, the third modification module 24 can be used to rotate the temperature reduction unit 18 (e.g. a nozzle). The third modification module 24 may be a movable part, a rotating part, or a combination of both.

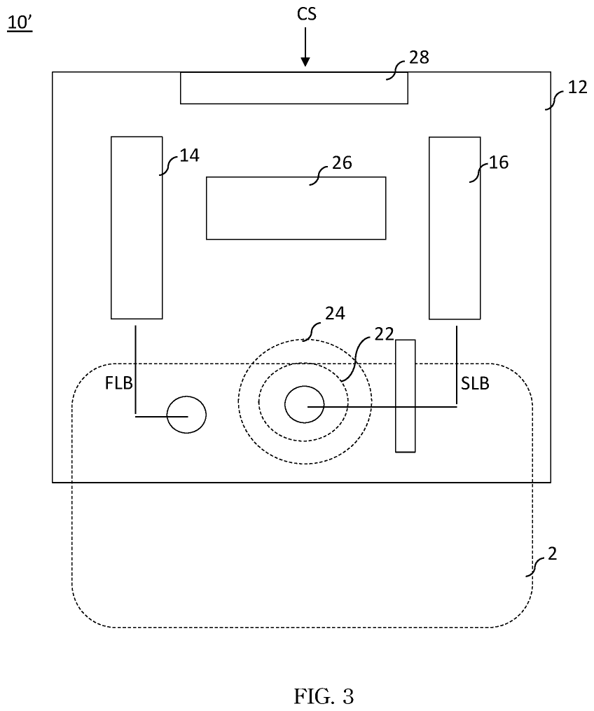

FIG. 3 is a schematic diagram depicting a top view of a laser light source module in accordance with a second embodiment of the present invention. In FIG. 3, the plate 2 is similarly subjected to treatments by a laser light source module 10′. In addition to the substrate 12, the first light source 14, the second light source 16, the temperature reduction unit 18, the first modification module 20, the second modification module 22 and the third modification module 24 described with respect to the first embodiment, the laser light source module 10′ further includes a processing unit 26 and an input/output (I/O) unit 28.

Details of the substrate 12, the first light source 14, the second light source 16, the temperature reduction unit 18, the first modification module 20, the second modification module 22 and the third modification module 24 have already been provided above, and thus omitted herein for conciseness.

In this embodiment, the first modification module 20, the second modification module 22 and the third modification module 24 are connected to and operatively driven by the processing unit 26. The processing unit 26 may execute any relevant instructions necessary for operating these modification modules.

In this embodiment, the I/O unit 28 is connected with the processing unit 26 for receiving external control signals CS and outputting control signals CS to the processing unit 26, so that the first modification module 20, the second modification module 22 and the third modification module 24 can be driven by the processing unit 26. In other embodiments, the processing unit 26 can be integrated into the I/O unit 28, such that the I/O unit 28 is directly connected with the first modification module 20, the second modification module 22 and the third modification module 24, and the first modification module 20, the second modification module 22 and the third modification module 24 are driven by the I/O unit 28 following the receiving of the control signals CS.

The present invention has been disclosed above in preferred embodiments. However, it can be appreciated by one with ordinary skill in the art that the above embodiments are used only to illustrate the present invention, and by no means are to be construed as to limit the scope of the present invention. It should be noted that any modifications or substitutions equivalent to the embodiments are deemed to be within the scope of the present invention. Therefore, the scope claimed of the present invention should be defined only by the following claims.

What is claimed is:

1. A laser light source module for subjecting a plate to treatment comprising:
a substrate defined with a setting area and an emitted area on two sides thereof, the plate being disposed in the emitted area;
a first light source disposed in the setting area for generating a first light beam to be emitted in the direction of the emitted area;
a second light source disposed in the setting area for generating a second light beam;
a temperature reduction unit disposed in the emitted area;
a first modification module coupled to the second light source for modifying an optical characteristic of the second light beam;
a second modification module disposed in the emitted area and coupled to the substrate for modifying the location of the plate that is subjected to at least one of the second light beam, the first light beam and the temperature reduction unit; and
a third modification module disposed in the emitted area, optionally co-axially disposed with the second modification module, and connected to the temperature reduction unit for modifying the angle at which the plate is required to be subjected to the temperature reduction unit.

2. The laser light source module of claim 1, wherein the first light beam is an ultraviolet (UV) laser and the second light beam is a carbon dioxide laser.

3. The laser light source module of claim 1, wherein the temperature reduction unit dissipates, by at least one of liquid, gas, and solid, heat energy produced when the plate is subjected to the first light beam and the second light beam.

4. The laser light source module of claim 1, wherein the first modification module is at least one of an optical component, a movable part and a rotating part for modifying at least one of the direction, the angle, the size, the focus and the optical path of the speckle of the second light beam.

5. The laser light source module of claim 4, wherein after the second light beam is modified by the first modification module, the optical axis of the second light beam is coincided or in parallel with the axis of the second modification module, wherein the second light beam is optionally emitted towards the plate via the second modification module.

6. The laser light source module of claim 1, wherein the second modification module is at least one of a movable part and a rotating part, and the second modification module simultaneously or independently modifies the locations of the plate that are subjected to the second light beam and the temperature reduction unit, wherein the number of the second modification module is one or more.

7. The laser light source module of claim 1, wherein the third modification module is at least one of a movable part and a rotating part.

8. The laser light source module of claim 1, further comprising a processing unit connected with the first modification module, the second modification module and the third modification module, which are operatively driven by the processing unit.

9. The laser light source module of claim 8, further comprising an input/output (I/O) unit connected with the processing unit for receiving a control signal and outputting the control signal to the processing unit to allow the first modification module, the second modification module and the third modification module to be driven by the processing unit.

10. The laser light source module of claim 1, further comprising an input/output (I/O) unit connected with the first modification module, the second modification module and the third modification module, and the first modification module, the second modification module and the third modification module are driven by the I/O unit upon receiving a control signal.
